(19) United States
(12) Patent Application Publication
(10) Pub. No.: US 2012/0314443 A1
(43) Pub. Date: Dec. 13, 2012

(54) Light Emitting and Power Storage Fixture

(76) Inventor: Calvin Wesley Moyer, Gilbert, AZ (US)

(21) Appl. No.: 13/472,373

(22) Filed: May 15, 2012

Related U.S. Application Data
(60) Provisional application No. 61/486,747, filed on May 16, 2011.
(60) Provisional application No. 61/506,085, filed on Jul. 9, 2011.

(51) Int. Cl. G02B 6/00; F21L 4/00

(52) U.S. Cl. 362/551; 362/157; 362/183

(57) ABSTRACT

A light collecting system flows light through a light receiving end of an optical fiber to a light emitting fixture. The light emitting fixture includes a collected lighting system, which includes a light emitting end of the optical fiber. The light emitting fixture includes a power storage system, which receives power in response to a first portion of the light flowing through the light emitting end of the optical fiber. The light emitting fixture includes a solid-state lighting system, which is powered by the power storage system. A second portion of the light flowing through the light emitting end of the optical fiber provides illumination.

### CROSS-REFERENCE TO RELATED APPLICATIONS

### Field of the Invention

This application is a continuation-in-part of U.S. Provisional Application No. 61/486,747, which was filed on May 16, 2011, the contents of which are incorporated by reference as though fully set forth herein.

This application is a continuation-in-part of U.S. Provisional Application No. 61/506,085, which was filed on Jul. 9, 2011, the contents of which are incorporated by reference as though fully set forth herein.

### BACKGROUND OF THE INVENTION

1. Field of the Invention

The invention relates to an apparatus which collects light and flows it to a desired location.

2. Description of the Related Art

There are many different types of lighting systems available which collect light, such as sunlight. Some of these lighting systems utilize sunlight by converting it into another form of energy, such as electrical energy, wherein the electrical energy is used to power an electrical device. Other lighting systems utilize sunlight by receiving and transmitting it to a useful location, such as inside a building, wherein it is used for illumination. Examples of lighting systems that utilize sunlight can be found in U.S. Pat. Nos. 3,088,025, 3,991,741, 4,249,516, 4,511,755, 4,525,031, 4,539,625, 4,968,355, 5,581,447, 5,709,456, 5,836,669, 6,037.535, 6,957,650, 6,958,868, 7,130,102, 7,190,531 and 7,566,137, as well as in U.S. Patent Application Nos. 2004/0187908 and 2006/0016448. More information that may be relevant to this disclosure can be found in U.S. Pat. No. 8,139.908, as well as the references included therein. More information that may be relevant to this disclosure can be found in U.S. Patent Application No. 20100014310, as well as the references included therein.

However, it is desirable to provide a lighting system, which provides electrical power in response to receiving the sunlight. It is also desirable to provide a lighting system which can store the electrical power, and utilize the stored electrical power to provide light.

### BRIEF SUMMARY OF THE INVENTION

The present invention involves a light fixture which receives light from a light collecting module, wherein a first portion of the light provides power to a power storage system and a second portion of the light provides illumination.

These and other features, aspects, and advantages of the present invention will become better understood with reference to the following drawings and description.

### BRIEF DESCRIPTION OF THE DRAWINGS

In the following drawings, like reference characters are used throughout the several views.

FIG. 1a is a block diagram of an apparatus, which includes a light collecting system in optical communication with a light emitting fixture.

FIG. 1b is a perspective view of one embodiment of the light collecting system of FIG. 1a, which includes a light collecting module.

FIG. 1c is a perspective view of one embodiment of the light collecting module of FIG. 1b.

FIG. 1d is a perspective view of another embodiment of the light collecting module of FIG. 1b.

FIG. 1e is a perspective view of one embodiment of the light emitting fixture of FIG. 1a.

FIG. 1f is a perspective view of another embodiment of the light emitting fixture of FIG. 1a.

FIG. 1g is a perspective view of another embodiment of the light emitting fixture of FIG. 1a.

FIG. 1h is a perspective view of another embodiment of the light emitting fixture of FIG. 1a.

FIG. 2a is a perspective view of one embodiment of a solid-state power system, which can be included with a light emitting fixture disclosed herein.

FIG. 2b is a perspective view of another embodiment of a solid-state power system, which can be included with a light emitting fixture disclosed herein.

FIG. 2c is a perspective view of another embodiment of a solid-state power system, which can be included with a light emitting fixture disclosed herein.

FIG. 2d is a perspective view of one embodiment of a power storage system, which can be included with a solid-state power system, disclosed herein.

FIG. 2e is a perspective view of one embodiment of a control assembly, which can be included with a solid-state power system disclosed herein.

FIG. 3a is a block diagram of one embodiment of the apparatus of FIG. 1a.

FIG. 3b is a perspective view of the apparatus of FIG. 3a.

FIG. 4a is a block diagram of one embodiment of the apparatus of FIG. 1a.

FIG. 4b is a perspective view of the apparatus of FIG. 4a.

FIG. 5a is a block diagram of one embodiment of the apparatus of FIG. 1a.

FIG. 5b is a perspective view of the apparatus of FIG. 5a.

FIG. 6a is a block diagram of one embodiment of the apparatus of FIG. 1a.

FIG. 6b is a perspective view of the apparatus of FIG. 6a.

FIG. 7a is a block diagram of one embodiment of the apparatus of FIG. 1a.

FIG. 7b is a perspective view of the apparatus of FIG. 7a.

### DETAILED DESCRIPTION OF THE INVENTION

The present invention provides an apparatus which collects light and transmits it to a useful location, such as inside a building. The light collected is typically sunlight, and is used for illumination. The collected light can be used to drive a solid-state power system so that power is stored for use. The power stored can be used to drive a solid-state lighting system so that it emits solid-state light. Hence, the apparatus can provide sunlight and solid-state light.

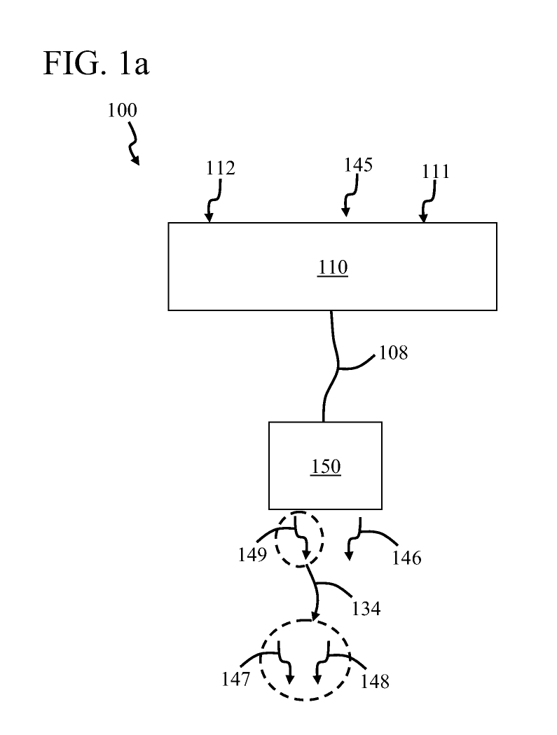

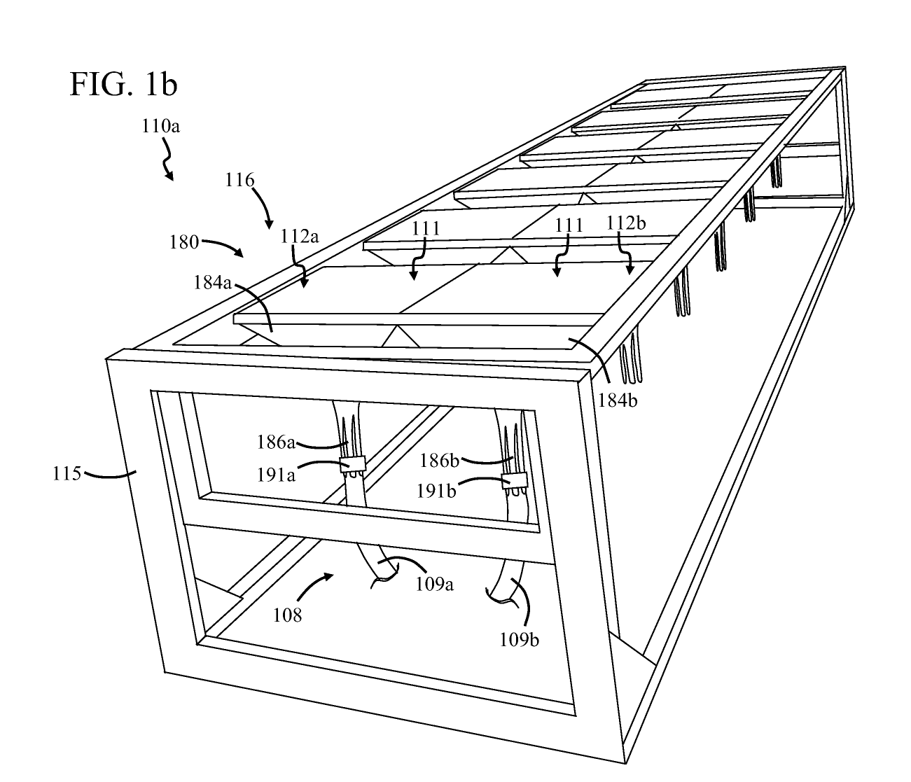

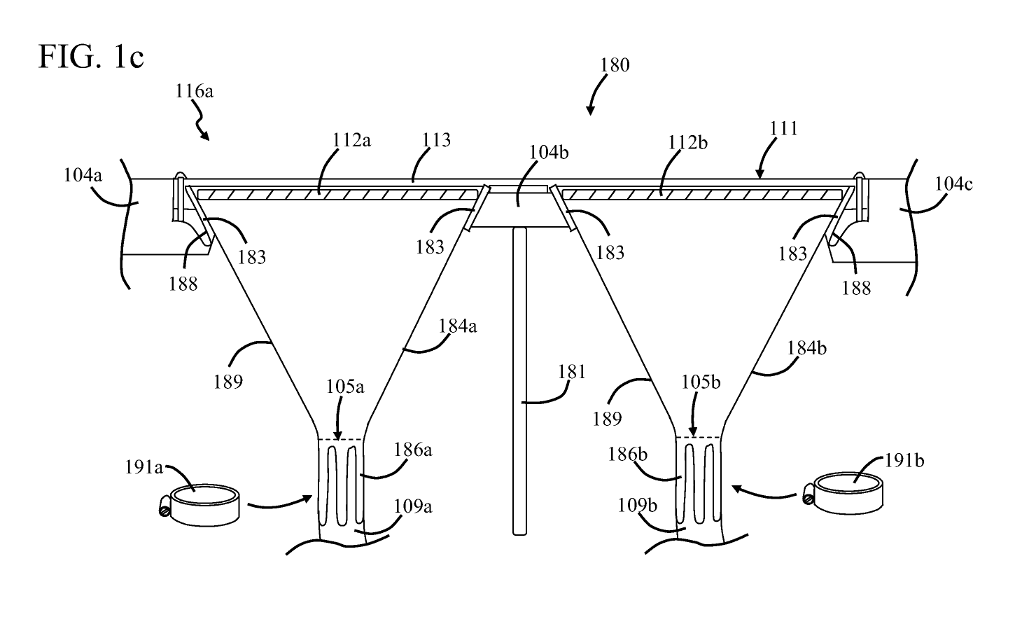

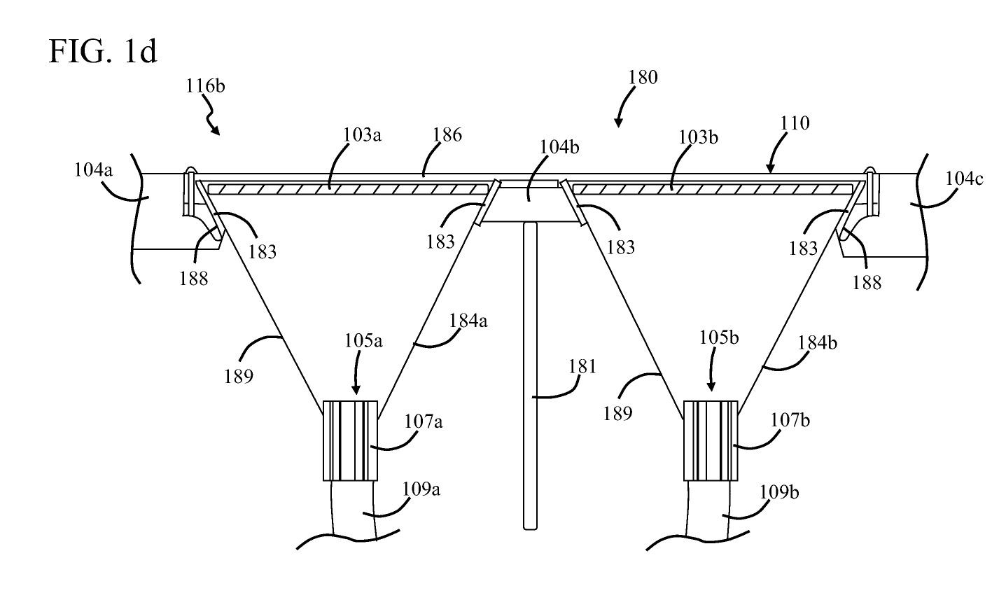

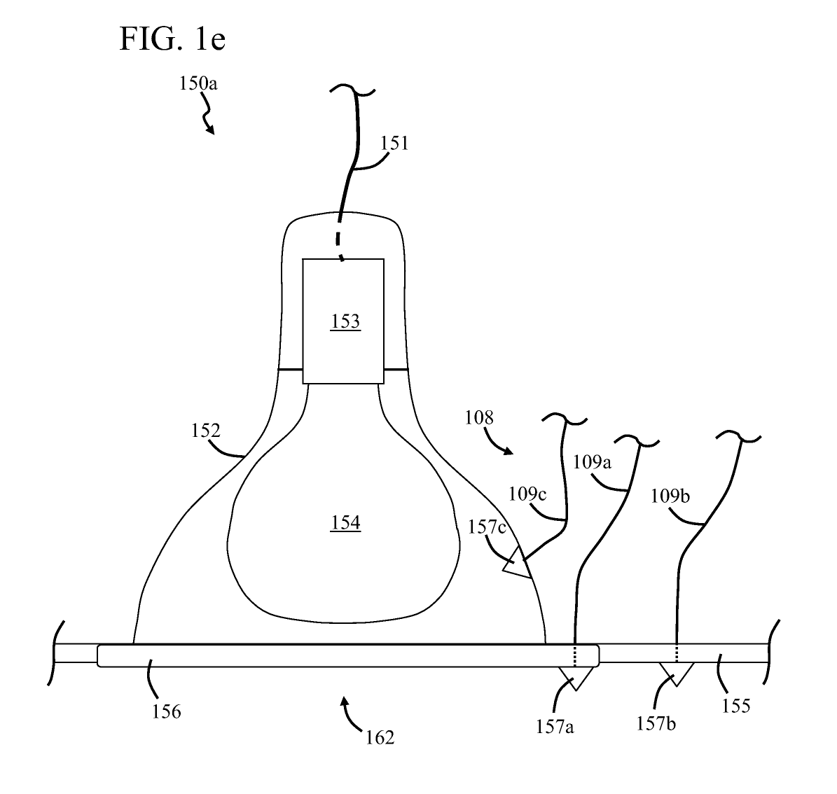

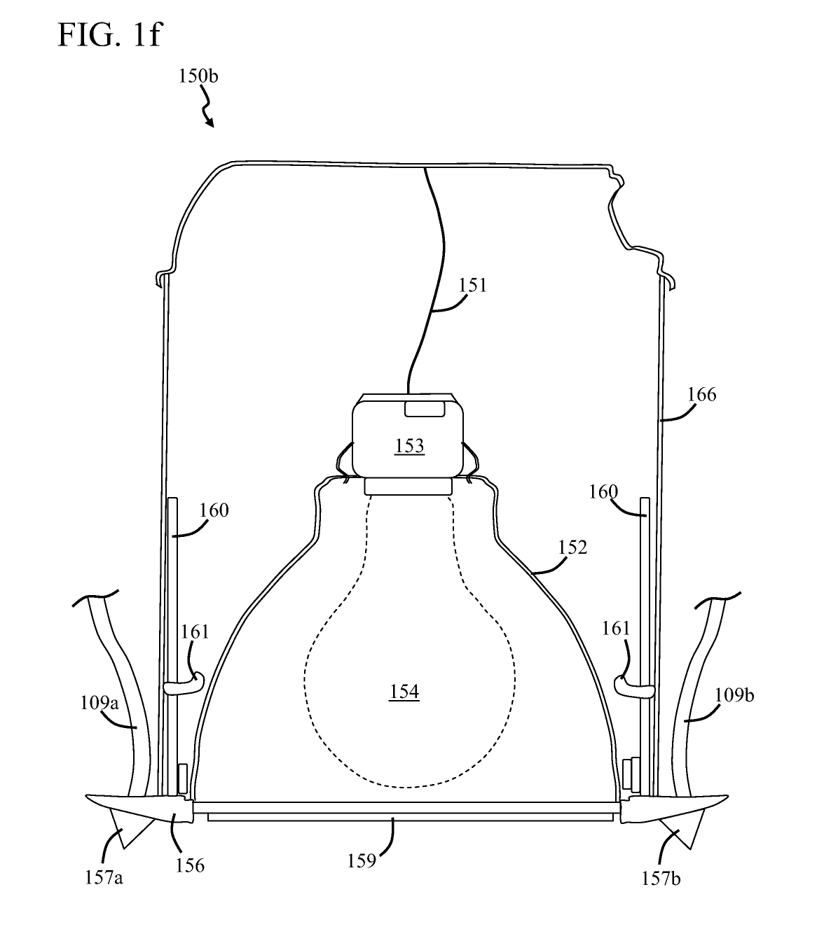

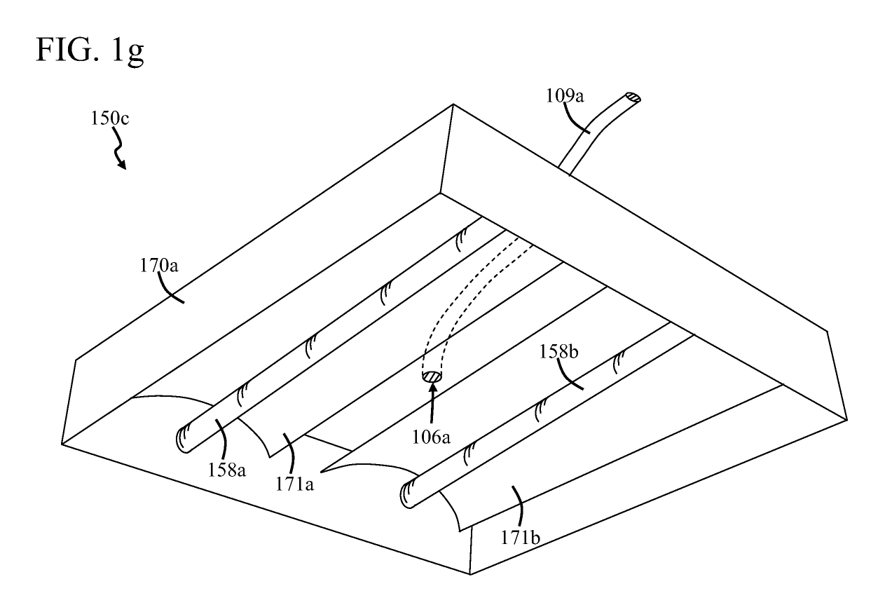

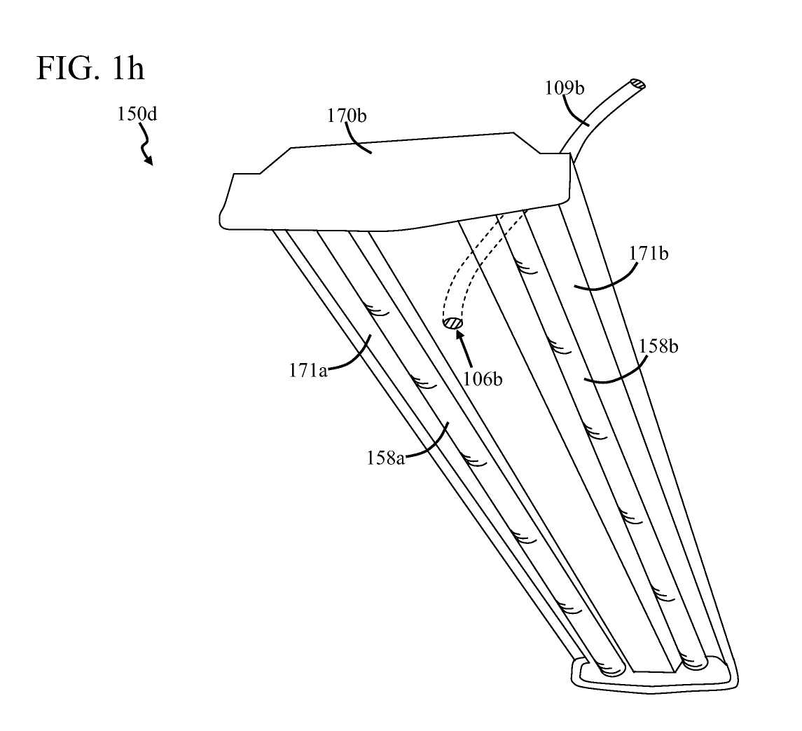

FIG. 1a is a block diagram of an apparatus 100, which, includes a light collecting system 110 in optical communication with a light emitting fixture 150, As will be discussed in more detail below with FIGS. 1b, 1c and 1d, light collecting system 110 includes a light collecting module 116. More information regarding light collecting system 110 and light collecting modules can be found in the above-referenced U.S. Pat. No. 8,139,908 and U.S. Patent Application No. 20100014310.

Light collecting system 110 can he in optical communication with light emitting fixture 150 in many different ways. In this embodiment, light collecting system 110 is in optical communication with light emitting fixture 150 through an optical fiber bundle 108. Optical fiber bundle 108 includes one or more optical fibers, as will be discussed in more detail below. In some embodiments, a portion or bundle 108 includes a light conduit. The light conduit 185 can include many different materials, such as rolled metal.

In operation, incident light 145 is collected in response to being received by light collecting system 110 at a light collecting surface 111. The collected light is flowed through a light, receiving end of optical fiber bundle 108 to light emitting fixture 150, wherein it is flowed outwardly from a light emitting end of bundle 108 as collected light 146. Hence, collected light 146 is the portion of incident light 145 that is collected by light collecting system 110 and flowed through optical fiber bundle 108. Incident light 145 can be of many different types of light, but it is generally includes sunlight. Collected light 146 includes sunlight when incident light 145 includes sunlight.

It should be noted that light collecting surface 111 is typically defined by a window 112 of the light collecting module. Window 112 can be of many different types, such as a plastic and glass plate. In general, window 112 includes a material that is optically transparent

to desired wavelengths of incident light 145 so that this light can be collected. If desired, a filtering layer can be positioned proximate to window 112 to filter undesired wavelengths of light, such as infrared. The filtering layer can be, for example, another window positioned proximate to window 112, or a coating layer carried by window 112. In one embodiment, window 112 is a Fresnel lens, several of which are disclosed in U.S. Pat. Nos. 5,151,826 and 6,282,034, The Fresnel lens can focus incident light 145 as it flows therethrough, and direct it to the optical fiber(s) of bundle 108.

In some embodiments, light emitting fixture 150 is capable of emitting generated light 149. Light emitting fixture 150 can emit generated light 149 in many different ways, such as with an electrical light source. The electrical light source is positioned proximate to the light emitting end of the optical fiber of optical fiber bundle 108, wherein collected light 146 flows through the light emitting end. The electrical light source can be of many different types, such as an incandescent light bulb, fluorescent light and light emitting diode. Light emitting diodes are solid-state light emitting devices which emit solid-state light 147 from a solid material such as semiconductor material. Incandescent light bulbs and fluorescent lights are non-solid state light emitting devices which emit non-solid-state light 148 from a gaseous material, wherein the gaseous material is not a solid material. As indicated by an indication arrow 134 in FIG. 1a, the generated light can include solid-state light 147. Further, as indicated by indication arrow 134 in FIG. 1a, the generated light can include non-solid-state light 148.

Light emitting fixture 150 is capable of emitting light from the electrical light source and/or optical fiber bundle 108. It should be noted that the light from the electrical light source typically does not include sunlight. In this way, light emitting fixture 150 is capable of emitting light that includes sunlight and light that does not include sunlight. It should be noted that, in this embodiment, collected light 146 flows through optical fiber bundle 108, but generated light 149 does not.

FIG. 1b is a perspective view of a light collecting system 110a, which can be included with light collecting system 110 of FIG. 1a. In this embodiment, light collecting system 110a includes a frame 115 which carries a light collecting module 180, which will be discussed in more detail below. Light collecting surface 111 is defined by windows 112a and 112b, which correspond to window 112 of FIG. 1a. Windows 112a and 112b are carried by light baffles 184a and 184b, respectively.

In this embodiment, optical fiber bundle 108 of FIG. 1a includes optical fibers 109a and 109b. Optical fibers 109a and 109b are coupled to light collecting module 180. Optical fibers 109a and 109b can be coupled to light collecting module 180 in many different ways. In this embodiment, light baffle 184a includes fingers 186a, and optical fiber 109a is coupled to fingers 186a with a clamp 191a. Further, light baffle 184b includes fingers 186b, and optical fiber 109b is coupled to fingers 186b with a clamp 191b, as will be discussed in more detail presently. It should be noted that clamps 191a and 191b are shown in more detail in FIG. 1c, and are often referred to as hose clamps. Examples of hose clamps are shown in U.S. Pat. Nos. 7,055,225 and 7,389.568.

FIG. 1c is a perspective view of a light collecting module 116a, which can be included with light collecting module 116 of FIG. 1b. In this embodiment, light baffles 184a and 184b are coupled to a frame 180. Light baffles 184a and 184b can be coupled to frame 180 in many different ways. In this embodiment, light baffle 184a includes opposed tapered sides 189 which are sized and shaped to be received by corresponding tapered sides 188 of transverse frame members 104a and 104b. Further, light baffle 184b includes opposed tapered sides 189 which are sized and shaped to be received by corresponding tapered sides 188 of transverse frame members 104b and 104c. In this way, light baffles 184a and 184b are slidingly engaged with frame 180. In this embodiment, cushion members 183 are positioned between the tapered sides of light baffle 184a and 184b and tapered sides 188. Cushion members 183 allow a certain amount of play between light baffles 184a and 184b and transverse frame members 104a, 104b and 104c in response to rotating arm 181 clockwise and counterclockwise, as described above.

In this embodiment, light baffle 184a includes fingers 186a, and optical fiber 109a is coupled to fingers 186a with clamp 191a. In operation, fingers 186a and optical fiber 109a extend through clamp 191a. Clamp 191a can be tightened to move fingers 186a against optical fiber 109a to hold them together. Further, clamp 191a can be untightened to move fingers 186a away from optical fiber 109a so that they can be moved apart.

In this embodiment, light baffle 184b includes fingers 186b, and optical fiber 109b is coupled to fingers 186b with clamp 191b. In operation, fingers 186b and optical fiber 109b extend through clamp 191b. Clamp 191b can be tightened to move fingers 186b against optical fiber 109b to hold them together. Further, clamp 191b can be untightened to move fingers 186b away from optical fiber 109b so that they can be moved apart.

It should be noted that optical fibers 109a and 109b and light baffles 184a and 184b rotate in response to the rotation of arm 181. Optical fibers 109a and 109b and light baffles 184a and 184b rotate relative to frame 115 (FIG. 1b) in response to the rotation of arm 181. Further, optical fibers 109a and 109b, optical fiber holders 107a and 107b and light baffles 184a and 184b rotate in response to the rotation of frame 180.

FIG. 1d Is a perspective view of a light collecting module 116b, which can be included with light collecting module 116 of FIG. 1b. In this embodiment, light baffles 184a and 184b are coupled to frame 180. Light baffles 184a and 184b can be coupled to frame 180 in many different ways. In this embodiment, light baffle 184a includes opposed tapered sides 189 which are sized and shaped to be received by corresponding tapered sides 188 of transverse frame members 104a and 104b. Further, light baffle 184b includes opposed tapered sides 189 which are sized and shaped to be received by corresponding tapered sides 188 of transverse frame members 104b and 104c. In this way, light baffles 184a and 184b are slidingly engaged with frame 180. in this embodiment, cushion members 183 are positioned between the tapered sides of light baffle 184a and 184b and tapered sides 188. Cushion members 183 allow a certain amount of play between light baffles 184a and 184b and transverse frame members 104a, 104b and 104c in response to rotating arm 181 clockwise and counterclockwise, as described above,

In this embodiment, light baffles 184a and 184b are coupled to optical fiber holders 107a and 107b, respectively. Light baffles 184a and 184b can be coupled to corresponding optical fiber holders 107a and 107b in many different ways. In this embodiment, light baffles 184a and 184b are coupled to corresponding optical fiber holders 107a and 107b using an adhesive. In other embodiments, a fastener, such as a hose clamp, is used to couple light baffles 184a and 184b to corresponding optical fiber holders 107a and 107b.

It should be noted that optical fibers 109a and 109b, optical fiber holders 107a and 107b and light baffles 184a and 184b rotate in response to the rotation of arm 181. Optical fibers 109a and 109b, optical fiber holders 107a and 107b and light baffles 184a and 184b rotate relative to light collecting module housing 101 in response to the rotation of arm 181. Further, optical fibers 109a and 109b, optical fiber holders 107a and 107b and light baffles 184a and 1.84b rotate in response to the rotation of frame 180.

Light fixture 150 of FIG. 1a can be of many different types of light fixtures, such as those disclosed in U.S. Pat. Nos. D555,825, D553,781, 4,238,815, 5,477,441, 5,570,947, 5,988,836, 6,231,214. Light emitting fixtures that can be modified so they operate as light emitting fixtures of the invention are provided by many different manufacturers, such as Tech Lighting, Ledtronics, Renoma Lighting, Con-tech Lighting, Amerilux Lighting, Halo (a division of Cooper Lighting), Litton lighting, Starfire, SF Designs, Jesco Lighting, Access Lighting, Thomas Lighting, Iris Lighting Systems, W.A.C. Lighting, LBL Lighting, Leucos, Nora Lighting, Lucifer Lighting, Bruck Lighting Systems, Visualle Architectural Decor, and Lum-Tech, among others.

FIG. 1e is a perspective view of a light emitting fixture 150a, which can be included with light emitting fixture 150 of FIG. 1b. In this embodiment, light emitting fixture 150 includes a light baffle 152 and power connector 153 operatively coupled to an electrical light source 154. Electrical light source 154 receives power from a power cord 151 through power connector 153, wherein power cord 151 flows an electrical power signal that operates source 154. In this way, electrical light source 154 emits light in response to receiving an electrical signal. Electrical light source 154 can be of many different types, such as one or more light emitting diodes, but here it is embodied as a light bulb. The light bulb can be of many different types, such as a fluorescent light, halogen light and incandescent light, among others. It should be noted that these types of light fixtures are often referred to as recessed canopy light fixtures.

Light emitting fixture 150 includes a faceplate assembly 156 and a lens 159, wherein lens 159 is held to light baffle 152 by faceplate assembly 156. It should be noted that, in some embodiments, light emitting fixture 150 does not include lens 159 and/or faceplate assembly 156.

One or more optical fibers extend proximate to light baffle 152. In this embodiment, three optical fibers are shown to illustrate the different positions they can be relative to light baffle 152, wherein the optical fibers are denoted as optical fibers 109a, 109b and 109c. Optical fibers 109a, 109b and 109c include a single optical fiber, but they generally include one or more. It should be noted that all of optical fibers 109a, 109b and 109c, or one or more of them, can be positioned as shown in FIG. 1e.

In this embodiment, a light disperser is coupled to the light emitting end of the optical fibers positioned proximate to light baffle 152. The light dispensers can be of many different types, but here they are embodied as prisms. In this embodiment, prisms 157a, 157b and 157c are coupled to the light emitting ends of optical fibers 109a, 109b and 109c, respectively. Prisms 157a, 157b and 157c can be coupled to the light emitting ends of optical fibers 109a, 109b and 109c, respectively, in many different ways. In this embodiment, prisms 157a, 157b and 157c are optically coupled, to the light emitting ends of optical fibers 109a, 109b and 109c, respectively.

Prisms 157a, 157b and 157c can be positioned at many different locations relative to light baffle 152. In this embodiment, prism 157a is positioned proximate to light baffle 152 and adjacent to ceiling 155. In this way, the light emitting end of optical fiber 109a emits light from a ceiling which carries light emitting fixture 150. Prism 157b is positioned proximate to light baffle 152 and adjacent to ceiling faceplate assembly 156. In this way, the light emitting end of optical fiber 109b emits light from a faceplate assembly of light emitting fixture 150. Further, prism 157c is positioned proximate and adjacent to light baffle 152. In this way, the light emitting end of optical fiber 109c emits light from a light baffle of light emitting fixture 150. it should be noted that all of prisms 157a, 157b and 157c, or one or more of them, can be positioned as shown in FIG. 1e.

The positioning of prisms 157a, 157b and 157c relative to electrical light source 154 allows light emitting fixture to provide a desired pattern of light, wherein electrical light source 154 emits generated light 149 and prisms 157a, 157b and/or 157c emit collected light 146 (FIG. 1a). Hence, light emitting fixture 150 is capable of emitting generated light 149 and/or collected light 146.

FIG. 1f is a perspective view of a light emitting fixture 150b, which can be included with light emitting fixture 150 of FIG. 1b. In this embodiment, light emitting fixture 150b includes opposed arms 160 coupled to faceplate assembly 156. Further, light emitting fixture 150b includes opposed pins 161 coupled to light baffle 152. Opposed arms 160 can be removeably coupled to opposed pins 161 in a repeatable manner so that faceplate assembly 156 can be repeatably moved between engaged and disengaged positions with light baffle 152. In this way, faceplate assembly 156 can be easily removed and replaced with another one. For example, faceplate assembly 156 can be removed and replaced with one that does not carry prisms. Further, if light emitting fixture 150b includes a faceplate assembly that is not modified to carry prisms 157a and/or 157b, it can be disengaged from light baffle 152 and replaced with one that is modified to carry prisms 157a and/or 157b.

In this embodiment, optical fibers 109a and 109b extend through opposed sides of faceplate assembly 156 and are optically coupled to prisms 157a and 157b, respectively. Prisms 157a and 157b are positioned on opposed sides of faceplate assembly 156 so that collected light 146 is flowed from opposed sides of light emitting fixture 150b. It should be noted that two optical fibers and two prisms are shown in this embodiment for illustrative purposes. However, in general, one or more optical fibers and their corresponding prisms can be included. The prisms are typically spaced apart from each other so that collected light 146 is flowed from light emitting fixture 150b in a desired pattern. In one particular embodiment, the prisms are equidistantly spaced apart from each other around the periphery of faceplate assembly 156. In some embodiments, collected light 146 is emitted from around faceplate assembly 156, as discussed in more detail presently.

FIG. 1b is a perspective view of a light emitting fixture 150c, which can be included with light emitting fixture 150 of FIG. 1b. In this embodiment, light emitting fixture 150c includes a Troffer light housing 170a, which carries Troffer light baffles 171a and 171b. Light emitting fixture 150c includes fluorescent lights 158a and 158b positioned proximate to Troffer light baffles 171a and 171b, respectively. Fluorescent lights 158a and 158b can be powered, in many different ways, such as by driving them with a power supply system. The power supply system can be of many different types, such as a building power supply system which is connected to a power grid.

FIG. 1h is a perspective view of a light emitting fixture 150d, which can be included with light emitting fixture 150 of FIG. 1b. In this embodiment, light emitting fixture 150d includes a Troffer light housing 170a, which carries Troffer light baffles 171a and 171b. Light emitting fixture 150d includes fluorescent lights 158a and 158b positioned proximate to Troffer light baffles 171a and 171b, respectively. As mentioned above, fluorescent lights 158a and 158b can be powered in many different ways, such as by driving them with a power supply system.

The light emitting fixtures disclosed herein can include other components, such as a solid-state power system and solid-state lighting system, as will be discussed in more detail presently.

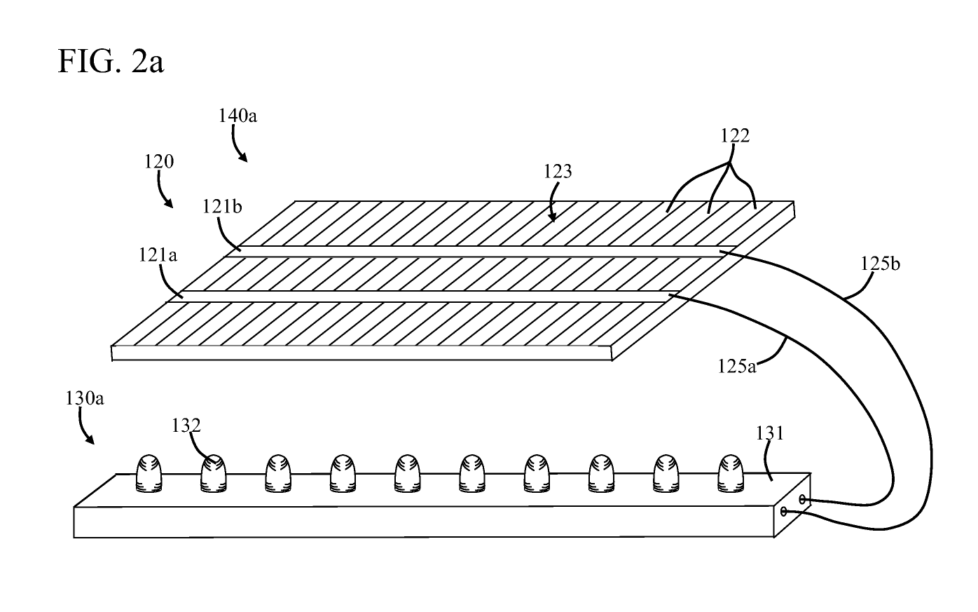

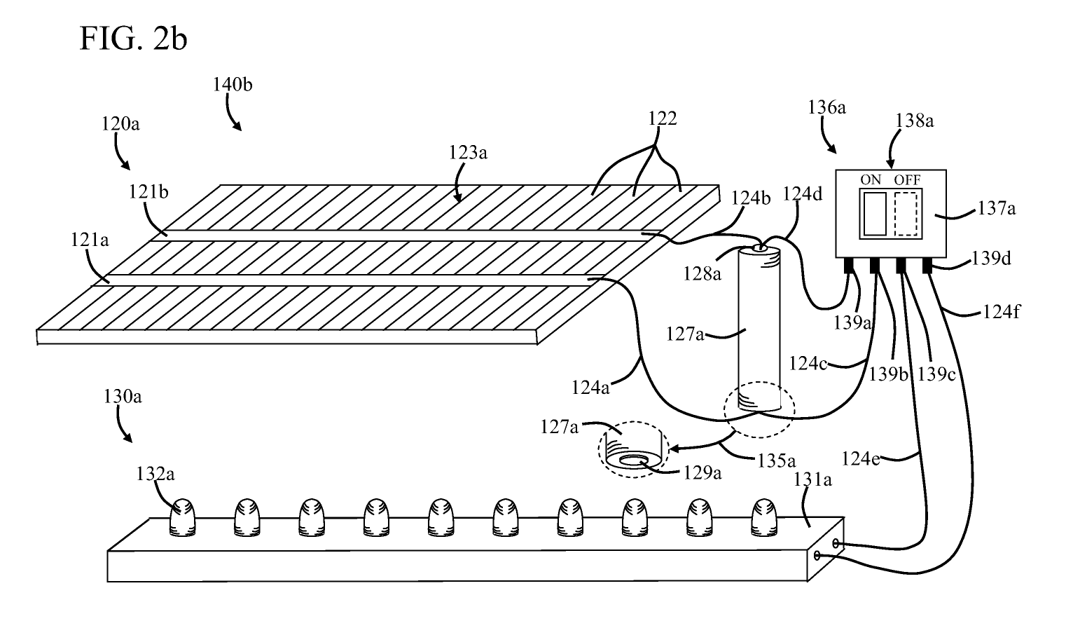

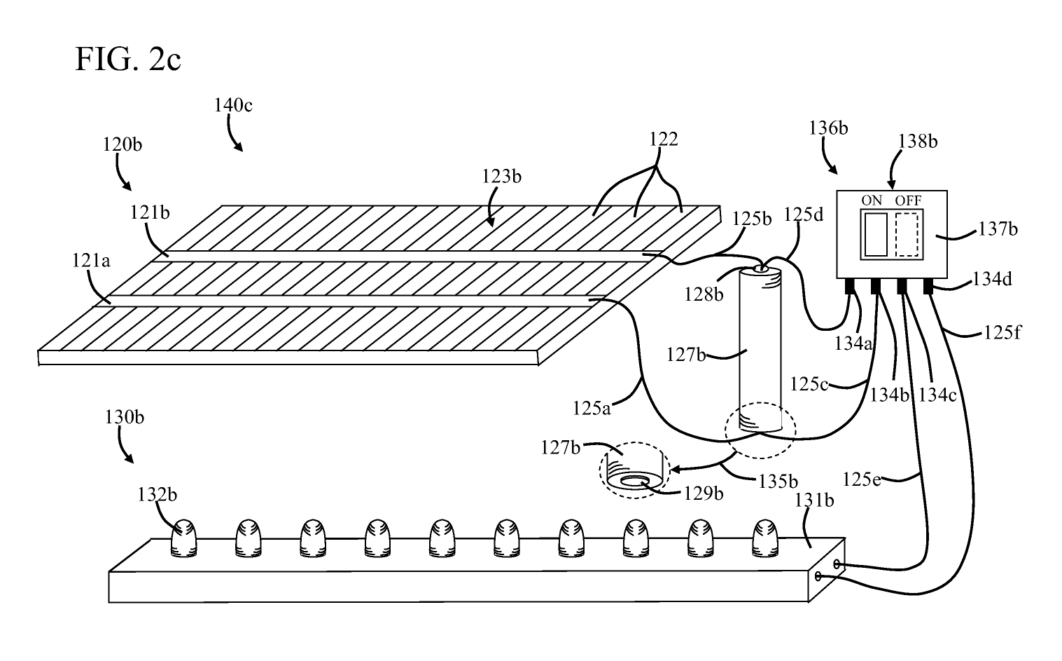

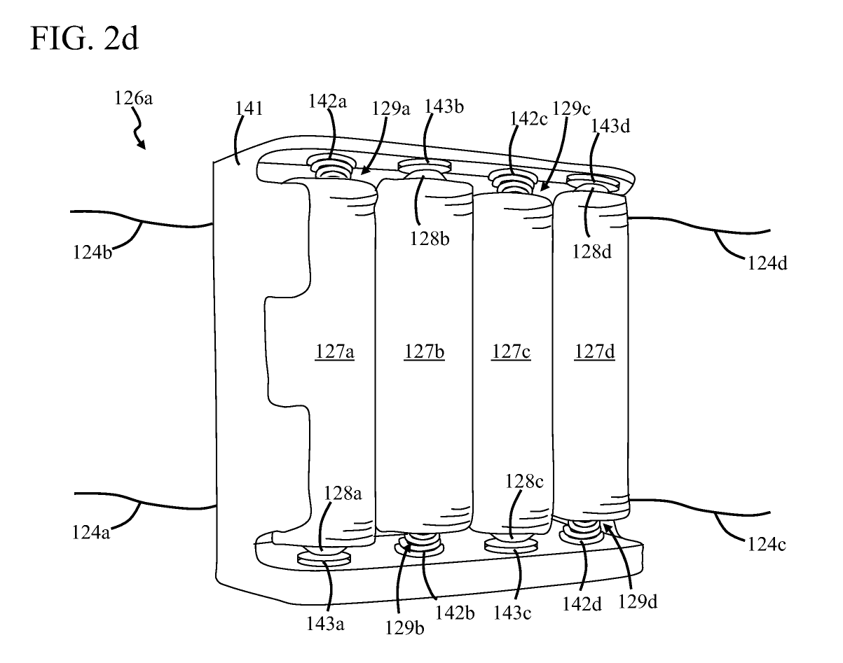

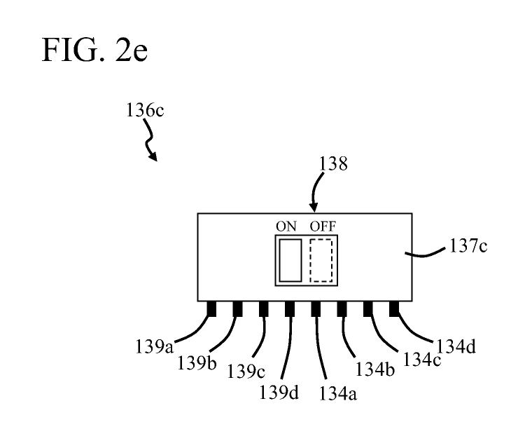

FIG. 2a is a perspective view of one embodiment of a solid-state power system, which is denoted as solid-state power system 140a, and a solid-state lighting system, which is denoted as solid-state lighting system 130a.

In this embodiment, solid-state power system 140a includes a solar array 120. Solar array 120 is manufactured by many different manufacturers, such as Kyocera Corporation of Kyoto, Japan and First Solar of Tempe, Ariz. In this embodiment, solar array 120 includes a plurality of solar ceils 122, and conductive strips 121a and 121b. In operation, a potential difference is established between conductive strips 121a and 121b in response to light being received by solar ceils 122 at a light receiving surface 123. In some embodiments, the potential difference established between conductive strips 121a and 121b is about twelve volts (12 V). In general, the potential difference established between conductive strips is between about five volts (5 V) and twenty volts (20 V). In this embodiment, the potential difference depends on the operating parameters of solid-state lighting system 130a.

In this embodiment, solid-state lighting system 130a includes a solid-state light housing 131 and a plurality of solid-state lights 132. Solid-state light housing 131 includes a rigid material in some embodiments, and a flexible material in other embodiments. Solid-state lights 132 can be of many different types of lights, such as light emitting diodes. The light emitting diodes of solid-state lighting system 130 can emit many different colors of light, such as red, green and/or blue light. The light emitting diode can also emit white light. Solid-state lighting system 130a is manufactured by many different manufacturers, such as Koninklijke Philips Electronics of Amsterdam, Netherlands and Elite LED of Houston, Tex. In this embodiment, solid-state lighting system 130a is sometimes referred to as an LED strip.

In this embodiment solid-state lighting system 130a is operatively coupled to solar array 120. Solid-state lighting system 130a can be operatively coupled to solar array 120 in many different ways, in this embodiment, solid-state lighting system 130a is operatively coupled to solar array 120 with conductive lines 125a and 125b, wherein conductive lines 125a and 125b are connected to conductive strips 121a and 121b, respectively. Conductive lines 125a and 125b are connected to conductive strips 121a and 121b so that solid-state light 132 operates in response to the potential difference being established between conductive strips 121a and 121b. As mentioned above, the potential difference is established between conductive strips 121a and 121b in response to light being received by solar cells 122.

FIG. 2b is a perspective view of one embodiment of a solid-state power system, which is denoted as solid-state power system 140b, and solid-state lighting system 130a. The operation of solid-state lighting system 130a is controlled by solid-state power system 140b, as will be discussed in more detail below.

In this embodiment, solid-state power system 140b includes a solar array 120a, which can be the same as solar array 120 of FIG. 2a. In this embodiment, solar array 120a includes the plurality of solar cells 122, and conductive strips 121a and 121b.

In this embodiment, solid-state power system 140b includes a battery 127a, which includes a projection terminal 128a and flat base terminal 129a. Flat base terminal 129a is indicated by an indication arrow 135a in FIG. 2b. In this embodiment, conductive strips 121a and 121b are connected to projection terminal 128a and flat base terminal 129a, respectively, by conductive lines 124b and 124a, respectively.

Battery 127a can be of many different types of batteries, such as a primary battery and a secondary battery. A primary battery is typically used once and then discarded and a secondary battery is rechargeable so that it can be used many times. Battery 127a can be of many different sizes, such as a D Cell, C Cell, AA Cell and AAA Cell, among others. Battery 127a can be of many different types, such as a lithium-ion battery, nickel-metal hydride battery and alkaline battery, among others. Lithium-ion batteries can be used to power an electronic device, such as a mobile phone and laptop computer.

In operation, a potential difference is established between conductive strips 121a and 121b in response to light being received by solar cells 122 at a light receiving surface 123a, as discussed in more detail above with FIG. 2a. The potential difference is established between projection terminal 128a and flat base terminal 129a because projection terminal 128a and flat base terminal 129a are connected to conductive strips 121a and 121b, respectively, as mentioned above. The potential difference is typically established between projection terminal 128a and flat base terminal 129a during the day so that battery 127a is charged during the day. As will be discussed in more detail below, solar array 120a receives sunlight during the day.

In this embodiment, solid-state power system 140b includes a control assembly 136a. Control assembly 136a can be of many different types of control assemblies, such as a switch. In this embodiment, control assembly 136a includes a control assembly housing 137a and control assembly switch 138a, wherein control assembly switch 138a is repeatably moveable between on and off positions.

In this embodiment control assembly 136a includes control terminals 139a, 139b, 139c and 139d. Control terminals 139a and 139b are connected to conductive lines 124d and 124c, respectively, wherein conductive lines 124d and 124c are connected to projection terminal 128a and flat base terminal 129a, respectively.

In this embodiment, control terminals 139c and 139d are connected to conductive lines 124e and 124f, respectively, wherein conductive lines 124e and 124f are connected to solid-state lighting system 130a.

In operation, conductive lines 124d and 124e are in communication with each other in response to control assembly switch 138a being in the on condition. Further, conductive lines 124d and 124e are not in communication with each other in response to control assembly switch 138a being in the off condition.

In operation, conductive lines 124c and 124f are in communication with each other in response to control assembly switch 138a being in the on condition. Further, conductive lines 124c and 124f are not in communication with each other in response to control assembly switch 138a being in the off condition.

In this embodiment, solid-state lighting system 130a includes solid-state light housing 131a and a plurality of solid-state lights 132a. Solid-state light housing 131a includes a rigid material in some embodiments, and a flexible material in other embodiments. Solid-state lights 132a can be of many different types of lights, such as light emitting diodes. The light emitting diode can emit many different colors of light, such as red, green and/or blue light. The light emitting diode can also emit white light. Solid-state lighting system 130a is manufactured by many different manufacturers, such as Koninklijke Philips Electronics of Amsterdam, Netherlands and Elite LED of Houston, Tex. In this embodiment, solid-state lighting system 130a is sometimes referred to as an LED strip.

In operation, solid-state lights 132a of solid-state lighting system 130a are activated in response to control assembly switch 138a being in the on condition because solid-state lights 132a are activated in response to receiving the potential difference between projection terminal 128a and flat base terminal 129a.

In particular, the potential difference between projection terminal 128a and flat base terminal 129a is applied to solid-state lights 132a of solid-state lighting system 130a in response to control assembly switch 138a being in the on condition. Solid-state lights 132a are activated in response to receiving the potential difference between projection terminal 128a and flat base terminal 129a. Battery 127a typically drives the operation of solid-state lighting system 130a during the night so that battery 127a is discharged during the night. As will be discussed in more detail below, solar array 120a does not receive sunlight during the night.

FIG. 2c is a perspective view of one embodiment of solid-state power system, which is denoted as solid-state power system 140c, and solid-state lighting system 130b. The operation of solid-state lighting system 130b is controlled by solid-state power system 140c, as will be discussed in more detail below.

In this embodiment, solid-state power system 140c includes a solar array 120b, which can be the same as solar array 120 of FIG. 2a. In this embodiment, solar array 120b includes a plurality of solar cells 122, and conductive strips 121a and 121b.

In this embodiment, solid-state power system 140c includes battery 127b, which includes a projection terminal 128b and flat base terminal 129b. Flat base terminal 129b is indicated by an indication arrow 135b in FIG. 2b. In this embodiment, conductive strips 121a and 121b are connected to projection terminal 128ba and flat base terminal 129b, respectively, by conductive lines 125b and 125a, respectively.

Battery 127b can be of many different types of batteries, such as a primary battery and a secondary battery. A primary battery is typically used once and then discarded and a secondary battery is rechargeable so that it can be used many times. Battery 127b can be of many different sizes, such as a D Cell, C Cell, AA Cell and AAA Cell, among others. Battery 127b can be of many different types, such as a lithium-ion battery, nickel-metal hydride battery and alkaline battery, among others.

In operation, a potential difference is established between conductive strips 121a and 121b in response to light being received by solar cells 122 at a light receiving surface 123b, as discussed in more detail above with FIG. 2a. The potential difference is established between projection terminal 128b and flat base terminal 129b because projection terminal 128b and flat base terminal 129b are connected to conductive strips 121a and 121b, respectively as mentioned above. The potential difference is typically established between projection terminal 128b and flat base terminal 129b during the day so that battery 127b is charged during the day. As will be discussed In more detail below, solar array 120b receives sunlight during the day.

In this embodiment, solid-state power system 140c includes a control assembly 136b. Control assembly 136b can be of many different types of control assemblies, such as a switch. In this embodiment, control assembly 136b includes a control assembly housing 137b and control assembly switch 138b, wherein control assembly switch 138b is repeatably moveable between on and off positions.

In this embodiment, control assembly 136b includes control terminals 134a, 134b, 134c and 134d. Control terminals 134a and 134b are connected to conductive lines 125d and 125c, respectively, wherein conductive lines 125d and 125c are connected to projection terminal 128b and flat base terminal 129b, respectively.

In this embodiment, control terminals 134c and 134d are connected to conductive lines 125e and 125f, respectively, wherein conductive lines 125e and 125f are connected to solid-state lighting system 130b.

In operation, conductive lines 125d and 125e are in communication with each other in response to control assembly switch 138b being in the on condition. Further, conductive lines 125d and 125e are not in communication with each other in response to control assembly switch 138b being in the off condition.

In operation, conductive lines 125c and 125f are in communication with each other in response to control assembly switch 138a being in the on condition. Further, conductive lines 125c and 125f are not in communication with each other in response to control assembly switch 138a being in the off condition.

In this embodiment, solid-state lighting system 130b includes solid-state light housing 131b and a plurality of solid-state lights 132b. Solid-state light housing 131a includes a rigid material in some embodiments, and a flexible material in other embodiments. Solid-state lights 132b can be of many different types of lights, such as light emitting diodes. The light emitting diodes can emit many different colors of light, such as red, green and/or blue light. The light emitting diodes an also emit white light. Solid-state lighting system 130b is manufactured by many different manufacturers, such as Koninklijke Philips Electronics of Amsterdam, Netherlands and Elite LED of Houston, Tex. In this embodiment, solid-state lighting system 130a is sometimes referred to as an LED strip.

In operation, solid-state lights 132b of solid-state lighting system 130b are activated in response to control assembly switch 138b being in the on condition because solid-state lights 132b are activated in response to receiving the potential difference between projection terminal 128b and flat base terminal 129b.

In particular, the potential difference between projection terminal 128b and flat base terminal 129b is applied to solid-state lights 132b of solid-state lighting system 130b in response to control assembly switch 138b being in the on condition. Solid-state lights 132b are activated in response to receiving the potential difference between projection terminal 128b and flat base terminal 129b. Battery 127b typically drives the operation of solid-state lighting system 130b during the night so that battery 127b is discharged during the night. As will be discussed in more detail below, solar array 120b does not receive sunlight during the night.

FIG. 2d is a perspective view of one embodiment of a power storage system, which is denoted as power storage system 126a. Power storage system 126a can be included with a light fixture disclosed herein, as will be discussed in more detail below. Further, power storage system 126a can be included with a solid-state power system, such as solid-state power systems 140b and 140c discussed in FIGS. 2b and 2c, respectively.

In this embodiment, power storage system 126a includes a power storage system housing 141, which carries a terminal. The terminal can be of many different types. In this embodiment, power storage system housing 141 carries a spring terminal 142a and a flat base terminal 143a, which are positioned opposed to each other.

In this embodiment, power storage system 126a includes battery 127a, which extends between spring terminal 142a and flat base terminal 143a. Battery 127a includes flat base terminal 129a and projection terminal 128a, wherein flat base terminal 129a and projection terminal 128a engage spring terminal 142a and flat base terminal 143a, respectively. In this way, battery 127a provides a potential difference of battery 127a between spring terminal 142a and flat base terminal 143a.

In this embodiment, power storage system housing 141 carries a spring terminal 142b and a flat base terminal 143b, which are positioned opposed to each other. Power storage system 126a includes battery 127b, which extends between spring terminal 142b and flat base terminal 143b. Battery 127b includes flat base terminal 129b and projection terminal 128b, wherein flat base terminal 129b and projection terminal 128b engage spring terminal 142b and flat base terminal 143b, respectively. In this way, battery 127b provides a potential difference of battery 127b between spring terminal 142b and flat base terminal 143b.

In this embodiment, power storage system housing 141 carries a spring terminal 142c and a flat, base terminal 143c, which are positioned opposed to each other. Power storage system 126a includes battery 127c, which extends between spring terminal 142c and flat base terminal 143c. Battery 127c includes flat base terminal 129c and projection terminal 128c, wherein flat base terminal 129c and projection terminal 128c engage spring terminal 142c and flat base terminal 143c, respectively. In this way, battery 127c provides a potential difference of battery 127c between spring terminal 142c and flat base terminal 143c.

In this embodiment, power storage system housing 141 carries a spring terminal 142d and a flat base terminal 143d, which are positioned opposed to each other. Power storage system 126a includes battery 127d, which extends between spring terminal 142d and flat base terminal 143d. Battery 127d includes flat base terminal 129d and projection terminal 128d, wherein flat base terminal 129d and projection terminal 128d engage spring terminal 142d and flat base terminal 143d, respectively. In this way, battery 127d provides a potential difference of battery 127d between spring terminal 142d and flat base terminal 143d.

Power storage system 126a can be included with solid-state power system 140b of FIG. 2b, wherein conductive lines 125b and 125d are connected to projection terminals 128a, 128b, 128c and 128d through flat base terminals 143a, 143b, 143c and 143d, respectively. Further, conductive lines 125a and 125c are connected to flat base terminals 129a, 129b, 129c and 129d through spring terminals 142a, 142b, 142c and 142d, respectively. In this way, the potential difference between conductive lines 125c and 125d is established by batteries 127a, 127b, 127c and 127d.

It should be noted that the amount of power that can be stored by solid-state power system 140b increases and decreases as the number of batteries included therein increases and decreases, respectfully. It should also be noted that power storage system 126a can also be included with solid-state power system 140c so that solid-state power system 140c can store more power.

FIG. 2e is a perspective view of one embodiment of a control assembly, which is denoted as control assembly 136c. It should be noted that, in some embodiments, the power storage systems disclosed herein include control assembly 136c of FIG. 2e and power storage system 126a of FIG. 2d. It is useful to include control assembly 136c with a light fixture which includes solid-state power systems 140a and 140b and solid-state lighting systems 130a and 130b.

In this embodiment, control assembly 136c includes control assembly housing 137c and control assembly switch 138, wherein control assembly switch 138 is repeatably moveable between on and off positions. Control assembly 136c includes control terminals 139a, 139b, 139c and 139d, which are also shown in FIG. 2b. Control terminals 139a, 139b, 139c and 139d can be connected to conductive lines 124d, 124c, 124e and 124f, respectively, as shown in FIG. 2b.

Control assembly 136c includes control terminals 134a, 134b, 134c and 134d, which are also shown in FIG. 2b. Control terminals 134a, 134b, 134c and 134d can be connected to conductive lines 125d, 125c, 125e and 125f, respectively, as shown in FIG. 2b.

In operation, conductive lines 124d and 124e are in communication with each other in response to control assembly switch 138 being in the on condition. Further, conductive lines 124d and 124e are not in communication with each other in response to control assembly switch 138 being in the off condition.

In operation, conductive lines 124c and 124f are in communication with each other in response to control assembly switch 138 being in the on condition. Further, conductive lines 124c and 124f are not in communication with each other in response to control assembly switch 138 being in the off condition.

In operation, conductive lines 125d and 125e are in communication with each other in response to control assembly switch 138 being in the on condition. Further, conductive lines 125d and 125e are not in communication with each other in response to control assembly switch 138 being in the off condition.

In operation, conductive lines 125c and 125f are in communication with each other in response to control, assembly switch 138 being in the on condition. Further, conductive lines 125c and 125f are not in communication with each other in response to control assembly switch 138 being in the off condition.

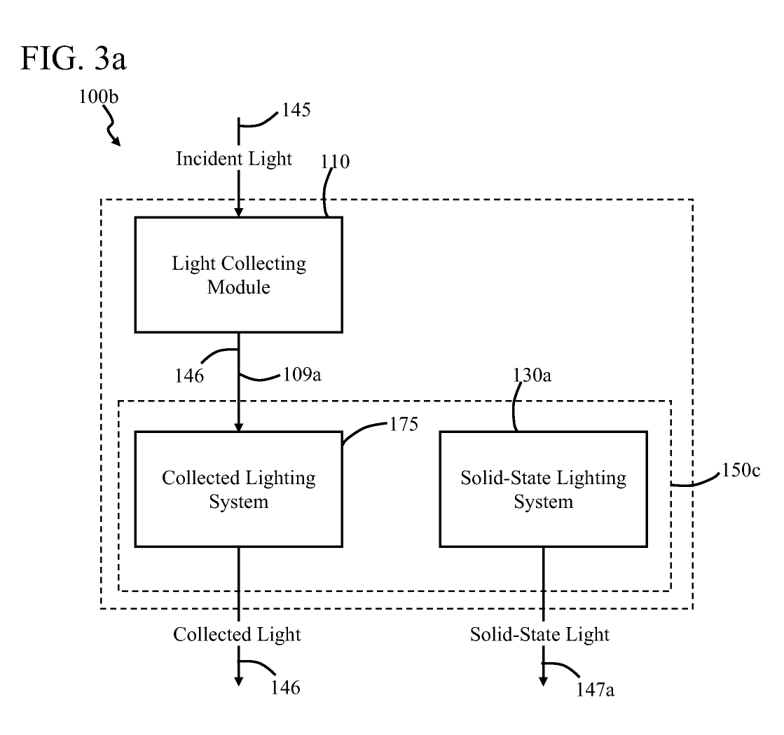

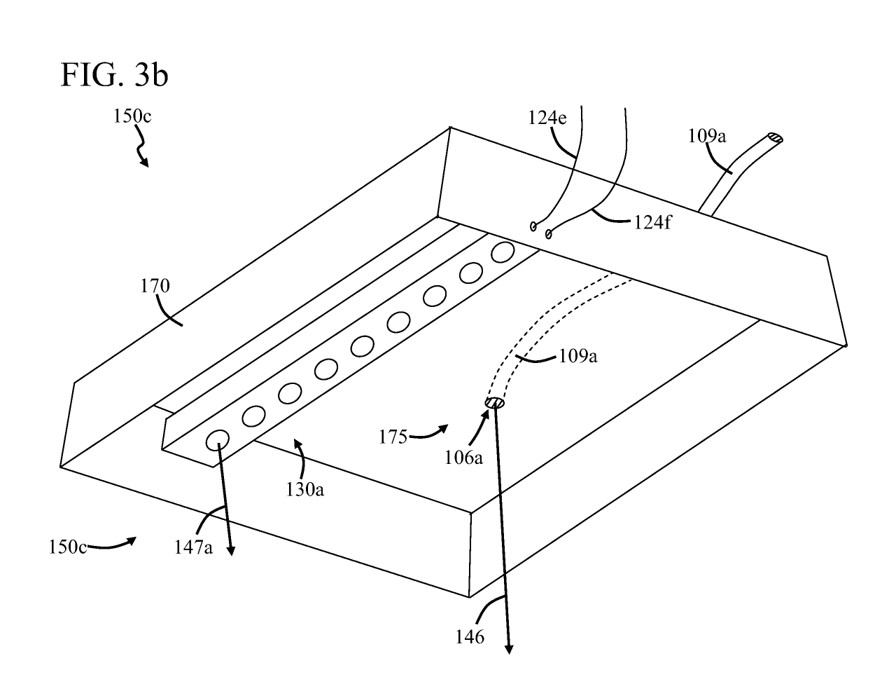

FIG. 3a is a block diagram of one embodiment of apparatus 100, which is denoted as apparatus 100b, and FIG. 3b is a perspective view of apparatus 100b. In this embodiment, apparatus 100b includes light collecting module 110 and light emitting fixture 150c optically coupled together, as described In more detail above with FIG. 1a. It should be noted that, in this embodiment, light collecting module 110 can be embodied as light collecting module 110a of FIG. 1b. In this embodiment, apparatus 100b includes optical fiber 109a which optically couples light collecting module 110 and light emitting fixture 150c together. Light collecting module 110 and light emitting fixture 150c together so that collected light 146 flows to light emitting fixture 150c in response to light collecting module 110 receiving incident light 145.

In this embodiment, light emitting fixture 150c includes a light housing 170 which carries a collected lighting system 175 and solid-state Sighting system 130a (FIGS. 2b and 3b). Light housing 170 can be of many different types of light housings, such as the light housings discussed herein. Solid-state lighting system 130a provides solid-state light 147a in response to a potential difference being established between conductive lines 124e and 124f. The potential difference can be established between conductive lines 124e and 124f in many different ways, such as by connecting conductive lines 124e and 124f to a solar array, as described above with FIGS. 2a, 2b and 2c. The potential difference between conductive lines 124e and 124f can also be established by connecting conductive lines 124e and 124f to a battery, as described above with FIGS. 2b, 2c and 2d. The batteries connected to conductive lines 124e and 124f can be carried by light housing 170 and positioned away from light housing 170.

In this embodiment, optical fiber 109a extends through light housing 170, as shown in FIG. 3b, so that collected lighting system 175 includes light emitting end 106a of optical fiber 109a. Collected lighting system 175 provides collected light 146, which flows through light emitting end 106a of optical fiber 109a.

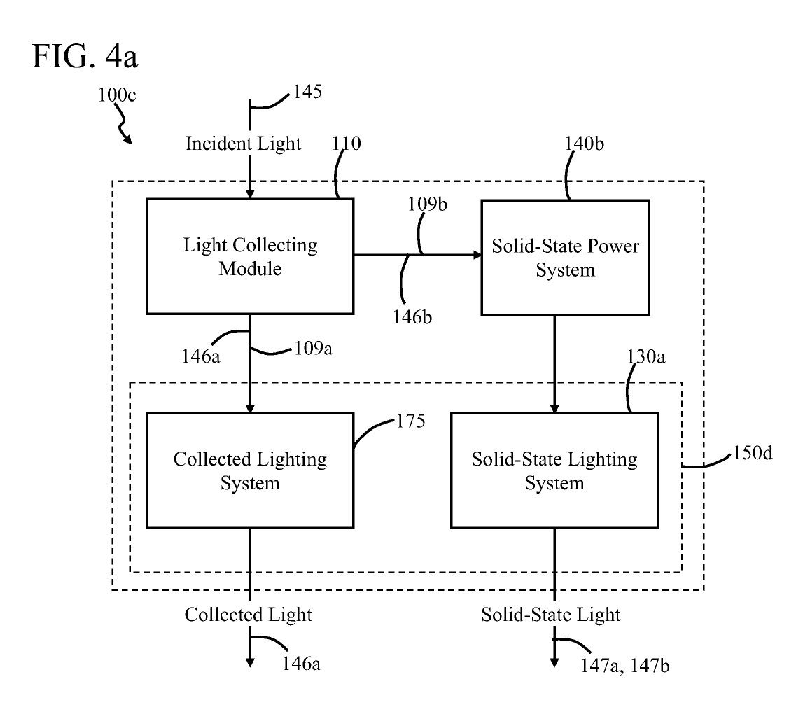

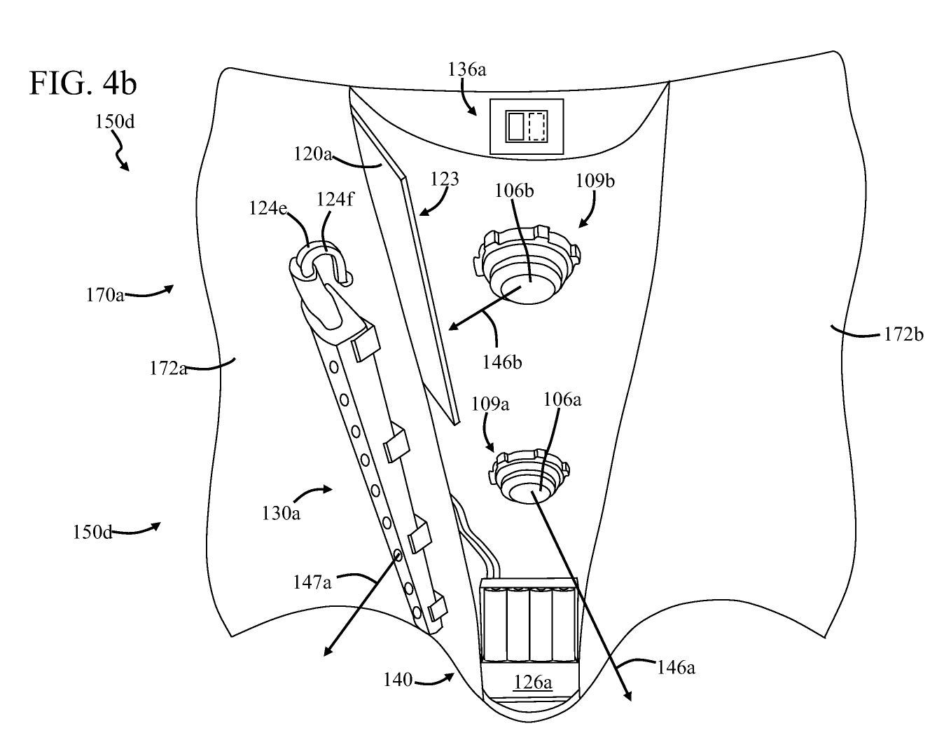

FIG. 4a is a block diagram of one embodiment of apparatus 100, which is denoted as apparatus 100c, and FIG. 4b is a perspective view of apparatus 100c. In this embodiment, apparatus 100c includes light collecting module 110 and a light emitting fixture 150d optically coupled together, as described in more detail above with FIG. 1a. It should be noted that, in this embodiment, light collecting module 110 can be embodied as light collecting module 110a of FIG. 1b. In this embodiment, light collecting module 110 and light emitting fixture 150d are optically coupled together through optical fiber 109a (FIGS. 1b, 1c and 1d). Further, apparatus 100c includes solid-state power system 140b, as shown in FIG. 2b, which is optically coupled to light collecting module 110. In this embodiment, light collecting module 110 and solid-state power system 140b are optically coupled together through optical fiber 109b (FIGS. 1b, 1c and 1d).

In this embodiment, apparatus 100c includes solid-state lighting system 130a, which is connected to solid-state power system 140b, as shown in FIG. 2b. Solid-state power system 140b includes solar array 120a connected to power storage system 126a of FIG. 2c. Power storage system 126a is connected to solid-state lighting system 130a through control assembly 136a, as described with FIGS. 2b and 2d.

In this embodiment, and as shown in FIG. 4b, light emitting fixture 150d includes light housing 170a which carries collected lighting system 175 and solid-state lighting system 130a. In this embodiment, collected lighting system 175 includes light emitting end 106a of optical fiber 109a. Optical fiber 109a extends through light housing 170a, as shown, in FIG. 4b.

In this embodiment, solid-state lighting system 130a and solar array 120a are carried by light baffle 172a, wherein light baffle 172a Is carried by light housing 170a. In this embodiment, solar array 120a and solid-state light emitting system 130a are positioned on opposed sides of light baffle 172a. Further, solar array 120a and solid-state light emitting system 130a face opposed directions. In this embodiment, light receiving surface 123a of solar array 120a faces light emitting end 106b of optical fiber 109b and solid-state light emitting system 130a faces away from light emitting end 106b of optical fiber 109b.

In operation, light collecting module 110 and light emitting fixture 150d are optically coupled together so that collected light 146a flows to light emitting fixture 150d in response to light collecting module 110 receiving incident light 145. It should be noted that, in this embodiment, collected light 146a is a portion of incident light 145, and collected light 146a provides illumination. Collected light 146a flows through light emitting end 106a of optical fiber 109a, as shown in FIG. 4b.

In operation, light collecting module 110 and solid-state power system 140b are optically coupled together so that collected light 146b flows to solid-state power system 140b in response to light collecting module 110 receiving incident light 145. In particular, collected light 146b flows from light emitting end 106b of optical fiber 109b to light receiving surface 123a of solar array 120a, as shown in FIG. 4b. It should be noted that collected light 146b is a portion of incident light 145.

Hence, in this embodiment, collected, lighting system 175 provides collected light 146a, and solid-state lighting system 130a provides solid-state light 147a. Further, solid-state lighting system 130a provides solid-state light 147a in response to a potential difference being established between conductive lines 124g and 124h (FIGS. 2b and 4b). The potential difference can be established between conductive lines 124g and 124h in many different ways, such as by establishing communication between conductive lines 124g and 124h and power storage system 126a in response to activating control assembly 136a. In this way, apparatus 100c provide collected light and solid-state light.

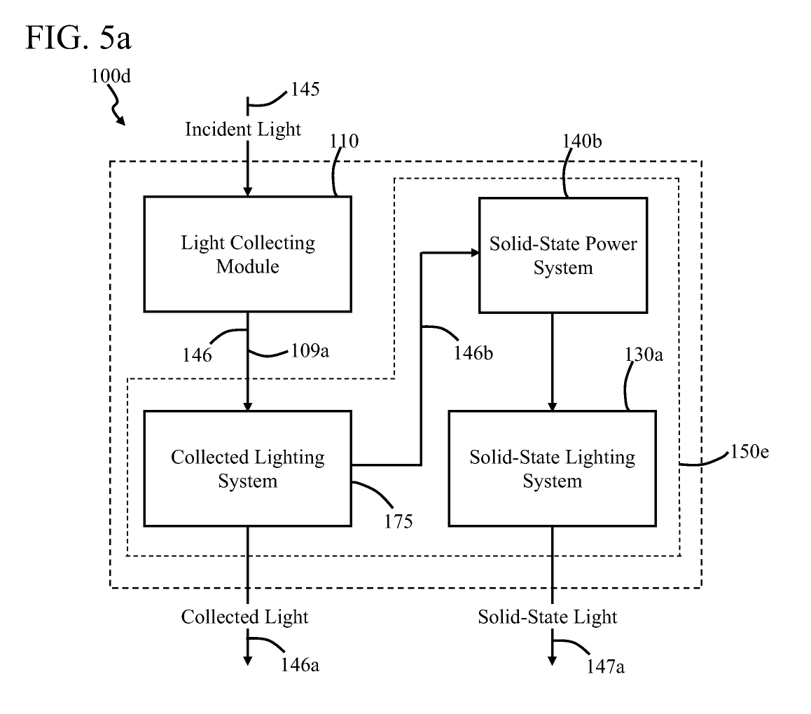

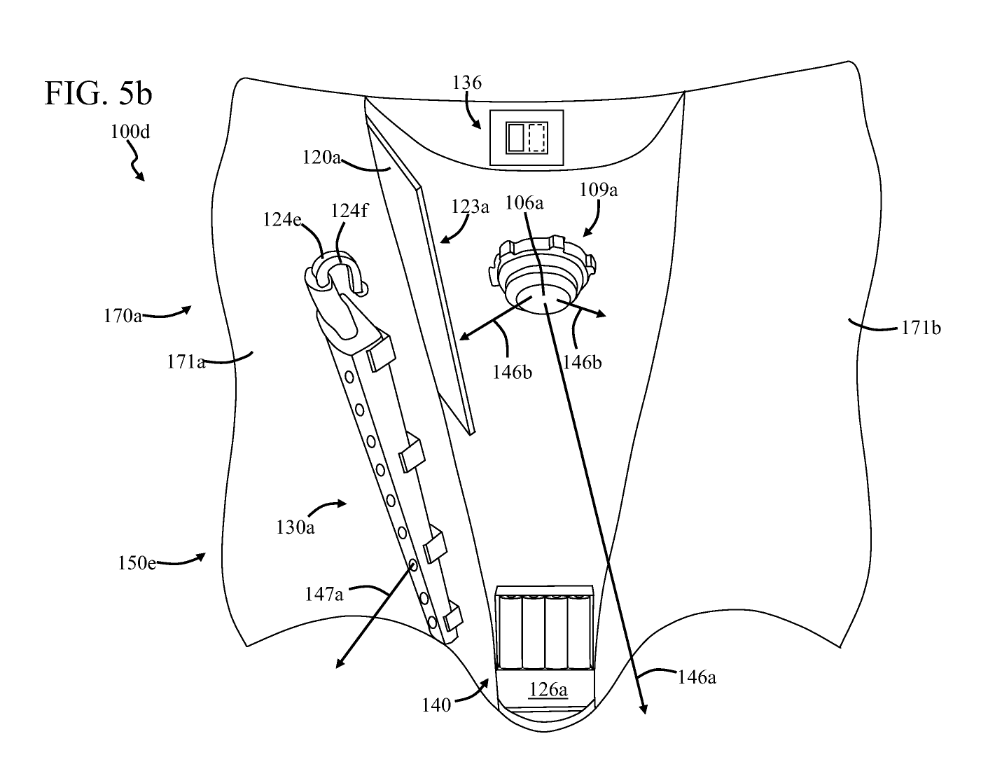

FIG. 5a is a block diagram of one embodiment of apparatus 100, which is denoted as apparatus 100d, and FIG. 5b is a perspective view of apparatus 100d. In this embodiment, apparatus 100d includes light collecting module 110 and a light emitting fixture 150e optically coupled together, as described in more detail above with FIG. 1a. It should be noted that, in this embodiment, light collecting module 110 can be embodied as light collecting module 110a of FIG. 1b. In this embodiment, light collecting module 110 and light emitting fixture 150e are optically coupled together through optical fiber 109a (FIGS. 1b, 1c and 1d). Further, apparatus 100d includes solid-state power system 140b, as shown in FIG. 2b, which is optically coupled to light collecting module 110. In this embodiment, light collecting module 110 and solid-state power system 140b are optically coupled together through optical fiber 109a.

In this embodiment, apparatus 100d includes solid-state lighting system 130a, which is connected to solid-state power system 140b, as shown in FIG. 2b. Solid-state power system 140b includes solar array 120a connected to power storage system 126a of FIG. 2d. Power storage system 126a is connected to solid-state lighting system 130a through control assembly 136a, as described with FIGS. 2b and 2d.

In this embodiment, and as shown in FIG. 5b, light emitting fixture 150e includes light housing 170a which carries collected lighting system 175 and solid-state lighting system 130a. In this embodiment, collected lighting system 175 includes light emitting end 106a of optical fiber 109a. Optical fiber 109a extends through light housing 170a, as shown in FIG. 5b.

In this embodiment, solid-state lighting system 130a and solar array 120a are carried by light baffle 172a, wherein light baffle 172a is carried by light housing 170a. In this embodiment, solar array 120a and solid-state light emitting system 130a are positioned on opposed sides of light baffle 172a. Further, solar array 120a and solid-state light emitting system 130a face opposed directions. In this embodiment, light receiving surface 123a of solar array 120a faces light emitting end 106b of optical fiber 109b and solid-state light emitting system 130a faces away from light emitting end 106b of optical fiber 109b.

In operation, light collecting module 110 and light emitting fixture 150e are optically coupled together so that collected light 146a flows to light emitting fixture 150e in response to light collecting module 110 receiving incident light. 145. It should be noted that, in this embodiment, collected light 146a is a portion of incident light 145, and collected light 146a provides illumination. Collected light 146a flows through light emitting end 106a of optical fiber 109a, as shown in FIG. 5b.

In operation, light collecting module 110 and solid-state power system 140b are optically coupled together so that collected light 146b flows to solid-state power system 140b in response to light collecting module 110 receiving incident light 145. In particular, collected light 146b flows from light emitting end 106a of optical fiber 109a to light receiving surface 123a of solar array 120a, as shown in FIG. 5b. It should be noted that collected light 146b is a portion of incident light 145. Further, collected light 146a and 146b are different portions of incident light 145.

Hence, in this embodiment, collected lighting system 175 provides collected light 146a, and solid-state lighting system 130a provides solid-state light 147a. Further, solid-state lighting system 130a provides solid-state light 147a in response to a potential difference being established between conductive lines 124e and 124f (FIGS. 2b and 5b). The potential difference can be established between conductive lines 124e and 124f in many different ways, such as by establishing communication between conductive lines 124e and 124f and power storage system 126a in response to activating control assembly 136a, as discussed in more detail above with FIG. 2b. In this way, apparatus 100d provide collected light and solid-state light.

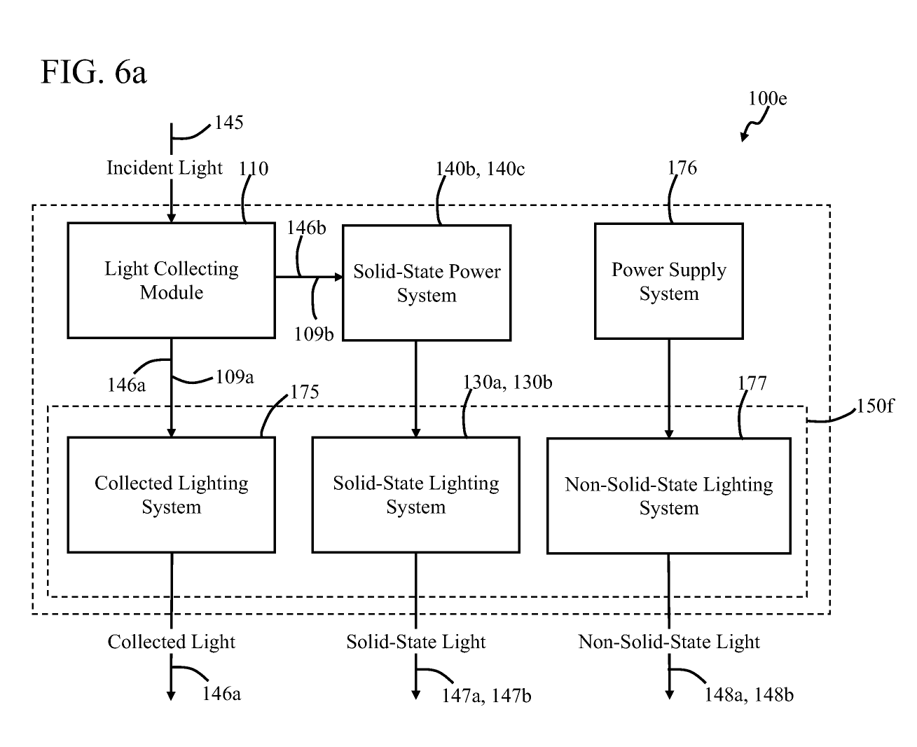

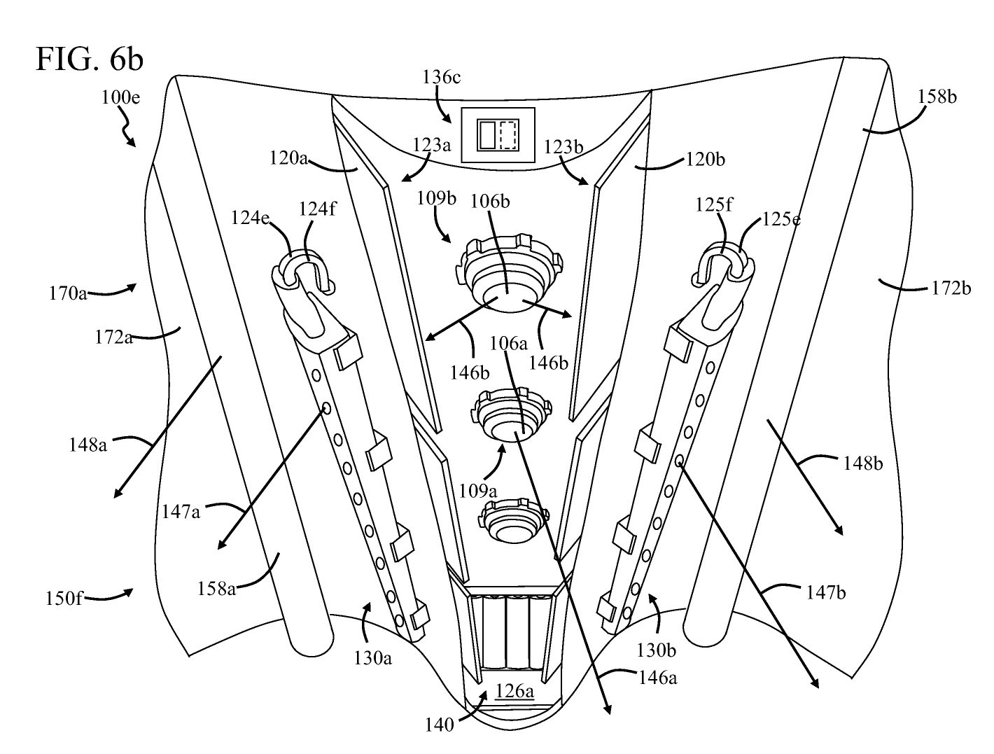

FIG. 6a is a block diagram of one embodiment of apparatus 100, which is denoted as apparatus 100e, and FIG. 6b is a perspective view of apparatus 100e. In this embodiment, apparatus 100e includes light collecting module 110 and a light emitting fixture 150f optically coupled together, as described in more detail above with FIG. 1a. it should be noted that, in this embodiment, light collecting module 110 can be embodied as light collecting module 110a of FIG. 1b. In this embodiment, light collecting module 110 and light emitting fixture 150f are optically coupled together through optical fiber 109a (FIGS. 1b, 1c and 1d). Further, apparatus 100c includes solid-state power systems 140b and 140c, which are shown in FIGS. 2b and 2c, respectively. Solid-state power systems 140b and 140c are optically coupled to light collecting module 110. In this embodiment, light collecting module 110 and solid-state power systems 140b and 140c are optically coupled together through optical fiber 109b (FIGS. 1b, 1c and 1d).

In this embodiment, apparatus 100e includes a non-solid-state lighting system 177. Non-solid-state lighting system 177 can be of many different types of lighting systems. In this embodiment, non-solid-state lighting system 177 includes fluorescent light sources 158a and 158b positioned to light baffles 172a and 172b, respectively. In this embodiment, apparatus 100e includes a power supply system 176 which provides power to non-solid-state lighting system 177. Power supply system 176 can provide power to non-solid-state lighting system 177 in many different ways. In this embodiment, power supply system 176 is coupled to a building power supply system which is connected to a power grid. In some embodiments, power supply system 176 includes a transformer for conditioning a power signal received from the power grip, wherein the conditioned power signal drives the operation of non-solid-state lighting system 177. Non-solid-state lighting system 177 provides non-solid-state light 148a and 148b in response to being driven by the conditioned power signal. In particular, fluorescent light sources 158a and 158b provide non-solid-state light 148a and 148b, respectively, in response to being driven by the conditioned power signal.

In this embodiment, apparatus 100e includes solid-state lighting system 130a, which is connected to solid-state power system 140b, as shown in FIG. 2b. Solid-state power system 140b includes solar array 120a connected to power storage system 126a of FIG. 2c. Power storage system 126a is connected to solid-state lighting system 130a through control assembly 136c, as described with FIGS. 2b, 2d and 2e.

In this embodiment, apparatus 100e includes solid-state lighting system 130b, which is connected to solid-state power system 140c, as shown in FIG. 2c. Solid-state power system 140c includes solar array 120b connected to power storage system 126a of FIG. 2d. Power storage system 126a is connected to solid-state lighting system 130b through control assembly 136c, as described with FIGS. 2b, 2d and 2e.

In this embodiment, and as shown in FIG. 6b, light emitting fixture 150f includes light housing 170a which carries collected lighting system 175 and solid-state lighting systems 130a and 130b. In this embodiment, collected lighting system 175 includes light emitting end 106a of optical fiber 109a. Optical fiber 109a extends through light housing 170a, as shown in FIG. 6b.

In this embodiment, solid-state lighting system 130a and solar array 120a are carried by light baffle 172a, wherein light baffle 172a is carried by light housing 170a. In this embodiment, solar array 120a and solid-state light emitting system 130a are positioned on opposed sides of light baffle 172a. Further, solar array 120a and solid-state light emitting system 130a face opposed directions. In this embodiment, light receiving surface 123a of solar array 120a faces light emitting end 106b of optical fiber 109b and solid-state light emitting system 130b faces away from light emitting end 106b of optical fiber 109b.

In this embodiment, solid-state lighting system 130b and solar array 120b are carried by light baffle 172b, wherein light baffle 172b is carried by light housing 170a. In this embodiment, solar array 120b and solid-state light emitting system 130b are positioned on opposed sides of light baffle 172b. Further, solar array 120b and solid-state light emitting system 130b face opposed directions. In this embodiment, light receiving surface 123b of solar array 120b faces light emitting end 106b of optical fiber 109b and. solid-state light emitting system 130b faces away from light emitting end 106b of optical fiber 109b.

In operation, light collecting module 110 and light emitting fixture 150f are optically coupled together so that collected light 146a flows to light emitting fixture 150f in response to light collecting module 110 receiving incident light 145. It should be noted that, in this embodiment, collected light 146a is a portion of incident light 145, and collected light 146a provides illumination. Collected light 146a flows through light emitting end 106a of optical fiber 109a, as shown in FIG. 6b.

In operation, light collecting module 110 and solid-state power systems 140b and 140c are optically coupled together so that collected light 146b flows to solid-state power systems 140b and 140c in response to light collecting module 110 receiving incident light 145. In particular, collected light 146b flows from light emitting end 106b of optical fiber 109b to light receiving surfaces 123a and 123b of solar arrays 120a and 120b, respectively, as shown in FIG. 6b. It should be noted that collected light 146b is a portion of incident light 145.

Hence, in this embodiment, collected lighting system 175 provides collected light 146a and 146b, and solid-state lighting systems 130a and 130b provide solid-state light 147a and 147b, respectively. Further, solid-state lighting system 130a provides solid-state light 147a in response to a potential difference being established between conductive lines 124e and 124f (FIGS. 2b and 6b). The potential difference can be established between conductive lines 124e and 124f in many different ways, such as by establishing communication between conductive lines 124e and 124f and power storage system 126a in response to activating control assembly 136c. In this way, apparatus 100e provide collected light and solid-state light.

Solid-state lighting system 130b provides solid-state light 147b in response to a potential difference being established between conductive lines 125e and 125f (FIGS. 2c and 6b). The potential difference can be established between conductive lines 125e and 125f in many different ways, such as by establishing communication between conductive lines 125e and 125f and power storage system 126a in response to activating control assembly 136c. In this way, apparatus 100e provides collected light, solid-state light and non-solid-state light.

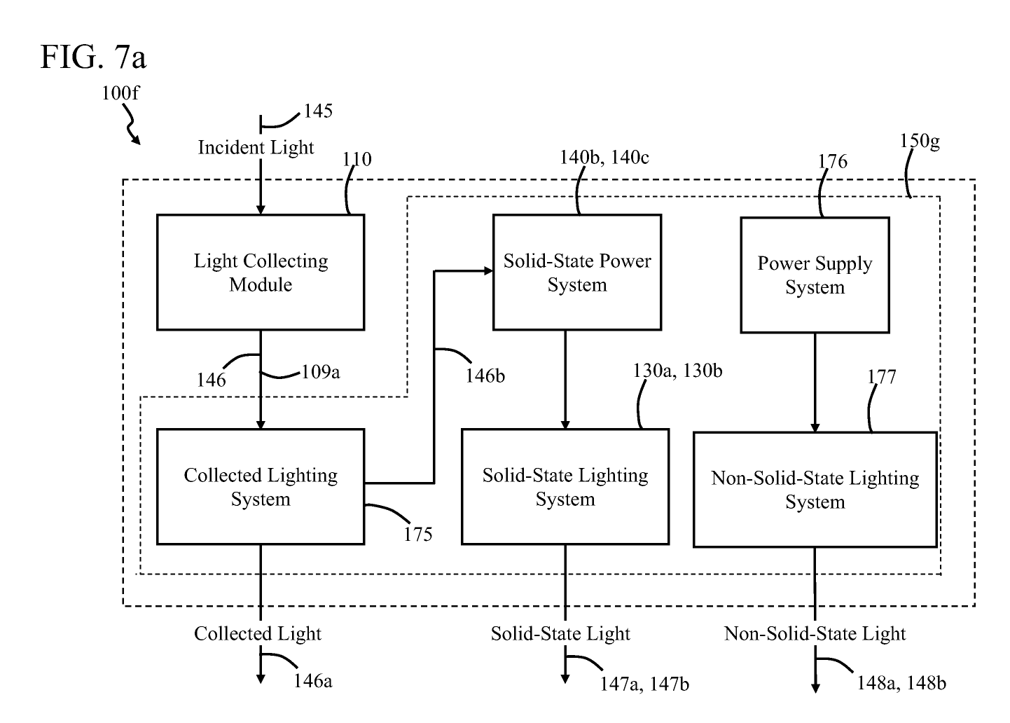

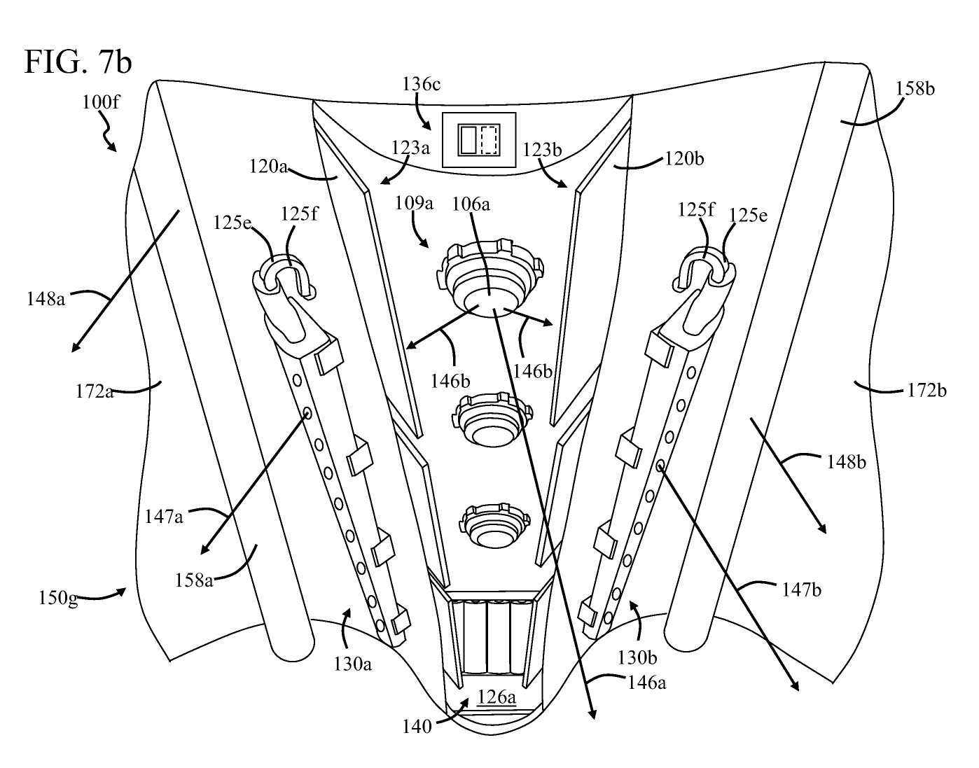

FIG. 7a is a block diagram of one embodiment of apparatus 100, which is denoted as apparatus 100f, and FIG. 7b is a perspective view of apparatus 100f. In this embodiment, apparatus 100f includes light collecting module 110 and a light emitting fixture 150g optically coupled together, as described in more detail above with FIG. 1a. It should be noted that, in this embodiment, light collecting module 110 can be embodied as light collecting module 110a of FIG. 1b. In this embodiment, light collecting module 110 and light emitting fixture 150g are optically coupled together through optical fiber 109a (FIGS. 1b, 1c and 1d). Further, apparatus 100f includes solid-state power systems 140b and 140c, as shown in FIGS. 2b and 2c, respectively. Solid-state power systems 140b and 140c are optically coupled to light collecting module 110. In this embodiment, light collecting module 110 and solid-state power systems 140b and 140c are optically coupled together through optical fiber 109a.

In this embodiment, apparatus 100f includes a non-solid-state lighting system 177. Non-solid-state lighting system 177 can be of many different types of lighting systems. In this embodiment, non-solid-state lighting system 177 includes fluorescent light sources 158a and 158b positioned to light baffles 172a and 172b, respectively. In this embodiment, apparatus 100e includes a power supply system 176 which provides power to non-solid-state lighting system 177. Power supply system 176 can provide power to non-solid-state lighting system 177 in many different ways. In this embodiment, power supply system 176 is coupled to a building power supply system which is connected to a power grid. In some embodiments, power supply system 176 includes a transformer for conditioning a power signal received from the power grip, wherein the conditioned power signal drives the operation of non-solid-state lighting system 177. Non-solid-state lighting system 177 provides non-solid-state light 148a and 148b in response to being driven by the conditioned power signal. In particular, fluorescent light sources 158a and 158b provide non-solid-state light 148a and 148b, respectively, in response to being driven by the conditioned power signal.

In this embodiment, apparatus 100f includes solid-state lighting system 130a, which is connected to solid-state power system 140b, as shown in FIG. 2b. Solid-state power system 140b includes solar array 120a connected to power storage system 126a of FIG. 2d. Power storage system 126a is connected to solid-state lighting system 130a through control assembly 136a, as described with FIGS. 2b and 2d.

In this embodiment, apparatus 100f includes solid-state lighting system 130b, which is connected to solid-state power system 140c, as shown in FIG. 2c. Solid-state power system 140c includes solar array 120ba connected to power storage system 126a of FIG. 2d. Power storage system 126a is connected to solid-state lighting system 130a through control assembly 136a, as described with FIGS. 2b and 2d.

In this embodiment, and as shown in FIG. 7b, light emitting fixture 150g includes light housing 170a which carries collected lighting system 175 and solid-state lighting systems 130a and 130b. In this embodiment, collected lighting system 175 includes light emitting end 106a of optical fiber 109a. Optical fiber 109a extends through light housing 170a, as shown in FIG. 7b.

In this embodiment, solid-state lighting system 130a and solar array 120a are carried by light baffle 172a, wherein light baffle 172a is carried by light housing 170a. In this embodiment, solar array 120a and solid-state light emitting system 130a are positioned on opposed sides of light baffle 172a. Further, solar array 120a and solid-state light emitting system 130a face opposed directions. In this embodiment, light receiving surface 123a of solar array 120a faces light emitting end 106a of optical fiber 109a and solid-state light emitting system 130a faces away from light emitting end 106a of optical fiber 109a.

In this embodiment, solid-state lighting system 130b and solar array 120ba are carried by light baffle 172b, wherein light baffle 172b is carried by light housing 170a. In this embodiment, solar array 120b and solid-state light emitting system 130b are positioned on opposed sides of light baffle 172b. Further, solar array 120b and solid-state light emitting system 130b face opposed directions. In this embodiment, light receiving surface 123b of solar array 120b faces light emitting end 106a of optical fiber 109a and solid-state light emitting system 130b faces away from light emitting end 106a of optical fiber 109a.

In operation, light collecting module 110 and light emitting fixture 150g are optically coupled together so that collected light 146a flows to light emitting fixture 150g in response to light collecting module 110 receiving incident light 145. It should be noted that, in this embodiment, collected light 146a is a portion of incident light 145, and collected light 146a provides illumination. Collected light 146a flows through light emitting end 106a of optical fiber 109a, as shown in FIG. 7b.

In operation, light collecting module 110 and solid-state power system 140b are optically coupled together so that collected light 146b flows to solid-state power system 140b in response to light collecting module 110 receiving incident light 145. In particular, collected light 146b flows from light emitting end 106a of optical fiber 109a to light receiving surface 123a of solar array 120a, as shown in FIG. 7b. It should be noted that collected light 146b is a portion of incident light 145. Further, collected light 146a and 146b are different portions of incident light 145.

In operation, light collecting module 110 and solid-state power system 140c are optically coupled together so that collected light 146b flows to solid-state power system 140c in response to light collecting module 110 receiving incident light 145. In particular, collected light 146b flows from light emitting end 106a of optical fiber 109a to light receiving surface 123b of solar array 120b, as shown in FIG. 7b. It should be noted that collected light 146b is a portion of incident light 145. Further, collected light 146a and 146b are different portions of incident light 145.

Hence, in this embodiment, collected lighting system 175 provides collected light 146a, and solid-state lighting systems 130a and 130b provide solid-state light 147a and 147b, respectively. Further, solid-state lighting system 130a provides solid-state light 147a in response to a potential difference being established between conductive lines 124e and 124f (FIGS. 2b and 7b). The potential difference can be established between conductive lines 124e and 124f in many different ways, such as by establishing communication between conductive lines 124e and 124f and power storage system 126a in response to activating control assembly 136c, as discussed in more detail above with FIG. 2b. In this way, apparatus 100f provide collected light and solid-state light.

Solid-state lighting system 130b provides solid-state light 147b in response to a potential difference being established between conductive lines 125e and 125f (FIGS. 2b and 7b). The potential difference can be established between conductive lines 125e and 125f in many different ways, such as by establishing communication between conductive lines 125e and 125f and power storage system 126a in response to activating control assembly 136c, as discussed in more detail above with FIG. 2b. In this way, apparatus 100f provides collected light, solid-state light and non-solid-state light.

The embodiments of the invention described herein are exemplary and numerous modifications, variations and rearrangements can be readily envisioned to achieve substantially equivalent results, all of which are Intended to be embraced within the spirit and scope of the invention.

1. Apparatus, comprising:
a light fixture which receives light from a light collecting module, wherein a first portion of the light provides power to a power storage system of the light fixture, and a second portion of the light provides illumination.

2. The apparatus of claim 1, further including an optical fiber which flows the light from the light collecting module to the light fixture.

3. The apparatus of claim 2, wherein the optical fiber includes a light receiving end which receives light incident to the light collecting module, and a light emitting end which provides the first and second portions of light.

4. The apparatus of claim 2, wherein the amount of light flowing through the optical fiber is adjustable in response to adjusting the light collecting module.

5. The apparatus of claim 1, wherein the power storage system includes a solar cell which receives the first portion of light.

6. The apparatus of claim 5, wherein the power storage system includes a solar cell and battery, wherein the battery stores the power in response to the solar cell receiving the first portion of light.

7. The apparatus of claim 6, further including a solid-state lighting system which is powered by the battery.

8. The apparatus of claim 1, further including a solid-state lighting system which is powered by the power storage system.

9. Apparatus, comprising:
a collected lighting system, wherein the collected lighting system includes an optical fiber with a light emitting end;
a power storage system which receives power in response to a first portion of collected light flowing through the light emitting end; and
a solid-state lighting system which is powered by the power storage system;
wherein a second portion of collected light flowing through the light emitting end provides illumination.

10. The apparatus of claim 9, wherein the optical fiber includes a light receiving end which receives light incident to a light collecting module.

11. The apparatus of claim 10, wherein the amount of light flowing through the optical fiber is adjustable in response to adjusting the light collecting module.

12. The apparatus of claim 9, wherein the power storage system includes a solar cell which receives the first portion of collected light flowing through the light emitting end.

13. The apparatus of claim 9, wherein the power storage system includes a solar cell and battery, wherein the battery stores the power in response to the solar cell receiving the first portion of collected light flowing through the light emitting end.

14. The apparatus of claim 12, further including a housing which carries the solar cell.

15. The apparatus of claim 12. further including a housing which carries the solar cell, wherein the optical fiber extends through the housing.

16. Apparatus, comprising:
a housing;
a collected lighting system carried by the housing, wherein the collected lighting system includes an optical fiber with a light emitting end;
a power storage system carried by the housing, wherein the power storage system stores power in response to collected light flowing through the light emitting end; and
a solid-state lighting system carried by the housing, wherein the solid-state lighting system is powered by the power storage system.

17. The apparatus of claim 16, further including a non-solid state lighting system carried by the housing.

18. The apparatus of claim 16, wherein the housing is a Troffer housing.

19. The apparatus of claim 16, wherein the power storage system includes a solar cell which receives light flowing through the light emitting end.

20. The apparatus of claim 16, wherein the power storage system includes a solar cell and battery, wherein the battery stores the power in response to the solar cell receiving light from the light emitting end.
